(19) United States
(12) Patent Application Publication
(10) Pub. No.: US 2004/0008674 A1
(43) Pub. Date: Jan. 15, 2004

(54) Digital cross connect switch matrix mapping method and system

(76) Inventor: Michel Dubois, Montreal (CA)

Correspondence Address: F. Drexel Feeling, Esq., Jones Day, North Point, 901 Lakeside Avenue, Cleveland, OH, 44114, US

(21) Appl. No.: 10/614,519

(22) Filed: Jul. 7, 2003

Related U.S. Application Data
(60) Provisional application No. 60/394,403, filed on Jul. 8, 2002.

(51) Int. Cl. H04Q 11/00

(52) U.S. Cl. 370/388; 370/401

(57) ABSTRACT

A method for generating switch matrix unit programming for switch matrix units of a cross connect device includes the step of obtaining information that identifies an input port of the cross connect device and a desired output port of the cross connect device for connecting to the identified input port. The method further includes identifying a pathway from a switch matrix unit in the cross connect device that provides the identified input port to a switch matrix unit in the cross connect device that provides the desired output port. The method further includes determining that sufficient channels exist in the identified pathway to allow a connection from the identified input port to the desired output port. Also, the method includes identifying specific channels in the identified pathway to allow a connection from the identified input port to the desired output port. In addition, the method includes storing in a programming data structure information identifying connections that have to be made in a plurality of switch matrix units in the cross connect device to allow the connection from the identified input port to the desired output port.

A digital cross connect system is provided that includes a switch matrix subsystem comprising a plurality of switch matrix units in a CLOS arrangement in multiple stages. The digital cross connect system also includes a plurality of subsystem input ports associated with the switch matrix subsystem and a plurality of subsystem output ports associated with the switch matrix subsystem. In addition, the digital cross connect system includes switch matrix unit programming that instructs the switch matrix units to generate specific internal cross-connections that allow one or more input signals present at one or more subsystem input ports to be connected to one or more subsystem output ports.

### CROSS-REFERENCE TO RELATED APPLICATIONS

This application claims the benefit of U.S. Provisional Application No. 60/394403 entitled “Digital Cross Connect Switch Matrix Mapping Method And System,” which was filed on Jul. 8, 2002. The entire disclosure of U.S. Provisional Application No. 60/394403 is hereby incorporated into the present application by reference.

### BACKGROUND

1. Field of the Invention

This invention relates generally to data communication networks. More particularly, the invention relates to a cross-connect switch matrix.

2. Description of the Related Art

Transport networks are well known in the data communication art. Transport networks include ATM networks, Frame Relay networks, the Synchronous Optical Network (“SONET”), Synchronous Digital Hierarchy (“SDH”) networks, and others. A transport network typically includes a plurality of network elements (elements) coupled together by one or more data communication channels (or paths). These network elements may, in turn, couple to local elements or networks, or may couple to other network structures.

Many of the network elements in the transport networks include switching hardware that are used to switch data from one data communication channel to another. The switching process in a network element is typically carried out using a hardware cross-connect switch matrix. The cross-connect switch matrix includes a plurality of input ports, a plurality of output ports, and a plurality of switches. There are many well know switch matrix architectures.

### SUMMARY

One invention defined by the claims provides a method for generating switch matrix unit programming for switch matrix units of a cross connect device. The method includes the step of obtaining information that identifies an input port of the cross connect device and a desired output port of the cross connect device for connecting to the identified input port. The method further includes identifying a pathway from a switch matrix unit in the cross-connect device that provides the identified input port to a switch matrix unit in the cross-connect device that provides the desired output port. The method further includes determining that sufficient channels exist in the identified pathway to allow a connection from the identified input port to the desired output port. Also the method includes identifying specific channels in the identified pathway to allow a connection from the identified input port to the desired output port. In addition, the method includes storing in a programming data structure information identifying connections that have to be made in a plurality of switch matrix units in the cross-connect device to allow the connection from the identified input port to the desired output port.

Another invention defined by the claims provides a digital cross-connect system that includes a switch matrix subsystem comprising a plurality of switch matrix units in a CLOS arrangement in multiple stages. Each switch matrix unit has a plurality of input ports and output ports. At least two of the switch matrix units have a number of their output ports uniquely connected to input ports on one of the switch matrix units in the next stage. At least two of the switch matrix units have an equal number of their output ports uniquely connected to input ports on another of the switch matrix units in the next stage. The digital cross-connect system also includes a plurality of subsystem input ports associated with the switch matrix subsystem and a plurality of subsystem output ports associated with the switch matrix subsystem. In addition the digital cross connect system includes switch matrix unit programming that instructs the switch matrix units to generate specific internal cross-connections that allow one or more input signals present at one or more subsystem input ports to be connected to one or more subsystem output ports.

Another invention defined by the claims provides a method for programming an apparatus having at least six switch matrix units wherein the six switch matrix units are organized in three stages with two switch matrix units in each stage. The inputs ports of the first stage switch matrix units are inputs ports for the apparatus and the output ports of the third stage switch matrix units are output ports for the apparatus. Each first stage and second stage switch matrix unit have output ports assigned to either an output set A or an output set B associated with that switch matrix unit. Each output port in output set A of a switch matrix unit is uniquely coupled to an input port in one of the two switch matrix units in the next stage and each output port in output set B of a switch matrix unit is uniquely coupled to an input port in the other of the two switch matrix units in the next stage. Each switch matrix unit is programmable to provide connections between its input ports and its output ports. The method includes calculating a path for a signal on an input port for the apparatus to an output port for the apparatus. The method further includes programming at least one of the first stage switch matrix units, at least one of the second stage switch matrix units and at least one of the third stage switch matrix units to each establish an internal connection that allows a signal appearing at the input port for the apparatus to be connected to an output port for the apparatus.

Another invention defined by the claims provides an apparatus that performs a switching function. The apparatus comprises a plurality of switch matrix units each having input ports and output ports. At least six of the switch matrix units are organized in three stages with two switch matrix units in each stage. The inputs ports of the first stage switch matrix units are inputs ports for the apparatus and the output ports of the third stage switch matrix units are output ports for the apparatus. Each first stage and second stage switch matrix unit has its output ports assigned to either an output set A or an output set B associated with that switch matrix unit. Each output port in output set A of a switch matrix unit is uniquely coupled to an input port in one of the two switch matrix units in the next stage and each output port in output set B of a switch matrix unit is uniquely coupled to an input port in the other of the two switch matrix units in the next stage. Each switch matrix unit is programmable to provide connections between its input ports and its output ports. The apparatus further includes switch matrix unit programming for each first stage, second stage, and third stage switch matrix units. The programming instructs at least one of the first stage switch matrix units, at least one of the second stage switch matrix units, and at least one of the third stage switch matrix units to each establish an internal connection that allows a signal appearing at one of the inputs of the apparatus to be switched to at least one of the outputs of the apparatus.

### BRIEF DESCRIPTION OF THE DRAWINGS

In order that the invention identified in the claims may be more clearly understood, preferred embodiments of structures, systems and methods having elements corresponding to elements of the invention recited in the claims will be described in detail by way of example, with reference to the accompanying drawings, in which:

FIG. 1 sets forth a block diagram of a preferred switch matrix subsystem that may be part of a digital cross connect system;

FIG. 2 is a diagram of an exemplary input vector IN[4N];

FIG. 3 is a diagram illustrated the type of information that may be contained in the input vector IN[4N];

FIG. 4 is a diagram of a exemplary output vector OUT[ ][ ];

FIG. 5 is a diagram illustrating the possible pathways for a signal entering switch matrix unit #1 and exiting switch matrix unit #5 in the exemplary embodiment;

FIG. 6 is a diagram illustrating the possible pathways for a signal entering switch matrix unit #1 and exiting switch matrix unit #6 in the exemplary embodiment;

FIG. 7 is a diagram illustrating the possible pathways for a signal entering switch matrix unit #2 and exiting switch matrix unit #5 in the exemplary embodiment;

FIG. 8 is a diagram illustrating the possible pathways for a signal entering switch matrix unit #2 and exiting switch matrix unit #6 in the exemplary embodiment;

FIG. 9 is a diagram illustrating examples of all possible pathways for a signal entering switch matrix unit #1 and exiting switch matrix units #5 and #6 in the exemplary embodiment;

FIG. 10 is a diagram illustrating examples of all possible pathways for a signal entering switch matrix unit #2 and exiting switch matrix units #5 and #6 in the exemplary embodiment;

FIG. 11 is a diagram illustrating examples of the preferred and alternate pathways for the broadcast connections in the exemplary switch matrix system;

FIG. 12 is a diagram illustrating examples of the preferred and alternate pathways for the normal connections in the exemplary switch matrix system;

FIG. 13 is a diagram illustrating an example of a possible scenario with one of the embodiments; and

FIG. 14 is a diagram illustrating an exemplary table NEW_OUT[ ] of size 4N that can be used when calculating routes.

### DETAILED DESCRIPTION

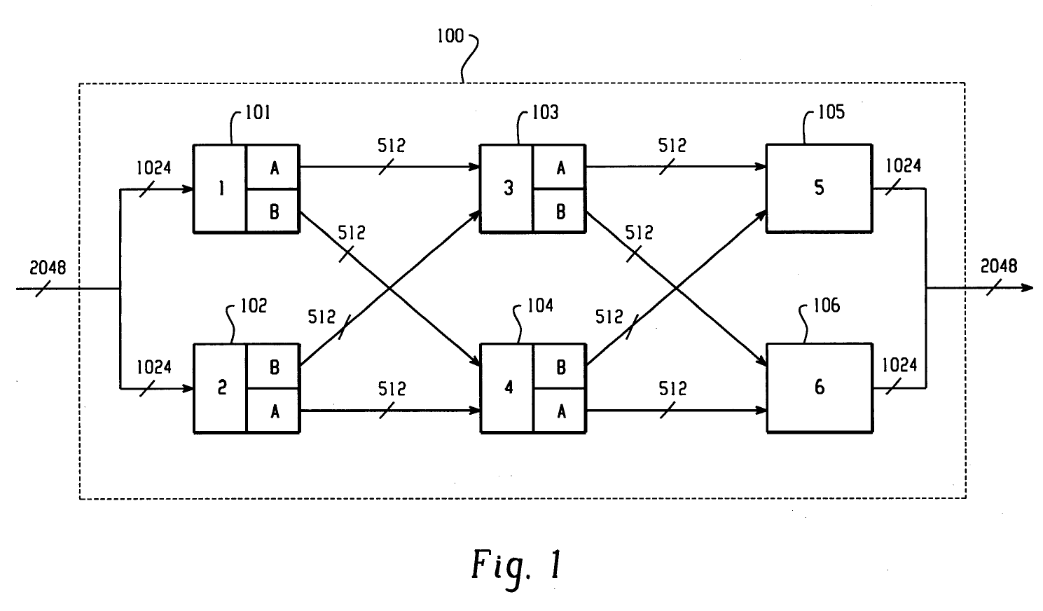

Turning now to the drawing figures, FIG. 1 sets forth a block diagram of a preferred switch matrix subsystem 100 that may be part of a digital cross connect system. The preferred switch matrix subsystem 100 shown includes a plurality (6 in this example) of switch matrix units 101, 102, 103, 104, 105, 106 (switch matrix units nos. 1-6). The switch matrix units 101, 102, 103, 104, 105, 106, in this example, are arranged in a “CLOS” architecture to form the switch matrix subsystem 100. The CLOS switch matrix subsystem 100 shown comprises three columns or stages of switch matrix units with two switch matrix units in each stage (i.e., two rows of switch matrix units corresponding to each column). In this example, each switch matrix unit 101, 102, 103, 104, 105, 106 is a 1024×1024 square matrix, each having 1024 input ports and 1024 output ports and each resides in a separate application specific integrated circuit (“ASIC”). The exemplary switch matrix subsystem 100, consequently, includes 2048 input ports 108 and 2048 output ports 110. A plurality of switch matrix subsystem 100 could be combined to form a larger switch device, wherein each switch matrix subsystem 100 may operate on a slice (such as a 2-bit slice) of data in a data word. For example, 4 switch matrix subsystem 100 could be combined to form a larger switch device, wherein each switch matrix subsystem 100 operates on a 2-bit slice of data and the overall switch device operates on an 8-bit data word. In this example, each of the 2048 input ports can input a 2-bit slice of information at a given instance and each of the 2048 output ports can output a 2-bit slice of information at a given instance.

By controlling the mapping of output ports to input ports within each switch matrix unit and the mapping of output ports from one switch matrix unit to the input ports of a switch matrix unit in the next stage, the output ports of switch matrix 100 can be connected to input ports of switch matrix subsystem 100 to effect the switching function to be performed by the switch matrix subsystem 100.

In switch matrix subsystem 100, the output ports in each of the switch matrix unit nos. 1-4 (101, 102, 103, and 104, respectively) are assigned to one of two output sets A or B. In the example shown, 512 output ports are assigned to output set A and 512 output ports are assigned to output set B. The output set A output ports in switch matrix units in one stage are coupled to input ports of switch matrix units in the next stage that are in the same row. The output set B output ports in switch matrix units in one stage are coupled to input ports of switch matrix units in the next stage that are in the opposite row. For example, each output port of output set A of switch matrix unit #1 is uniquely coupled to an input port of switch matrix unit #3, and each output port of output set B of switch matrix unit #1 is uniquely coupled to an input port of switch matrix unit #4. Within a switch matrix unit, any input can be connected to either an output set A output port or an output set B output port.

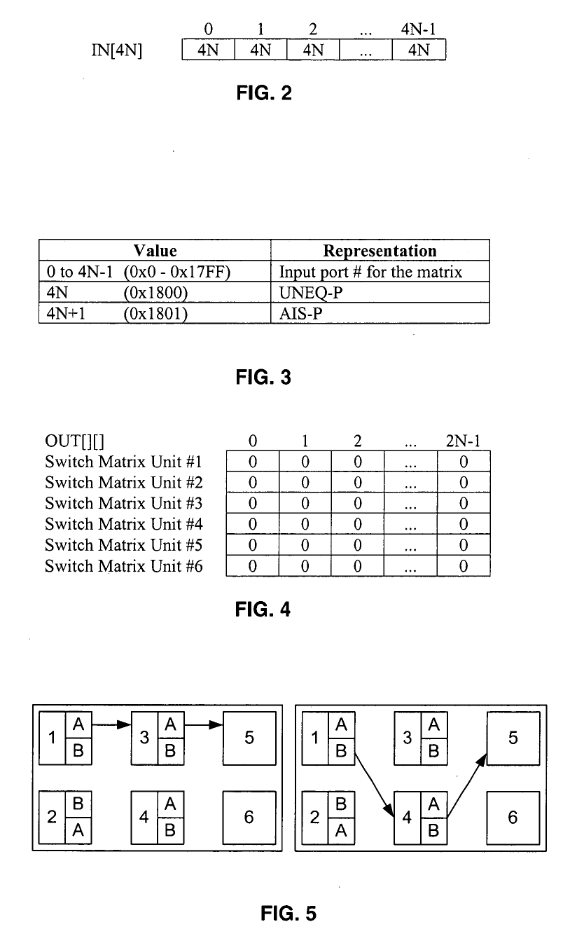

An exemplary input that is typically used for programming the switch matrix subsystem 100 typically comprises an input vector IN[4N], wherein N=½ of the number of input or output ports in each switch matrix unit and 4N equals the total number of inputs and outputs in the switch matrix subsystem 100. In this example 4N is equal to 2048. The input vector is IN[2048] shows the desired input to output mapping for the switch matrix 100. An exemplary input vector IN[4N] is illustrated at FIG. 2, wherein each column heading represents an output port location and the information contained within each column represents the input port to be switched to that output port or a status signal that indicates the status of the output port as illustrated in FIG. 3. Initially, all entries within the input vector would be set to a value, such as 4N, corresponding to a port unequipped state (“UNEQ-P”). As output ports are provisioned the entries for the provisioned output ports will be replaced with input port numbers.

The input vector is converted to an output vector OUT[ ][ ], as illustrated in FIG. 4, that shows the connections that have to be made within each switch matrix unit to effect the desired mapping of inputs of switch matrix subsystem 100 to outputs of switch matrix subsystem 100. Each column represents an output port for a switch matrix unit and each row represents a specific switch matrix unit. One or more algorithms can be utilized to identify the connections that have to be made within each switch matrix unit to generate the output vector OUT[ ][ ]. A couple of exemplary algorithms will be described below.

The switch matrix subsystem 100 is capable of handling unicast (normal) connections and broadcast connections. Normal connections are connections within switch matrix subsystem 100 wherein a single output is connected to a single input. With a normal connection, a signal enters the switch matrix subsystem 100 on a single input port on either switch matrix unit #1 or #2 and exits the switch matrix on a single output port on either switch matrix unit #5 or #6.

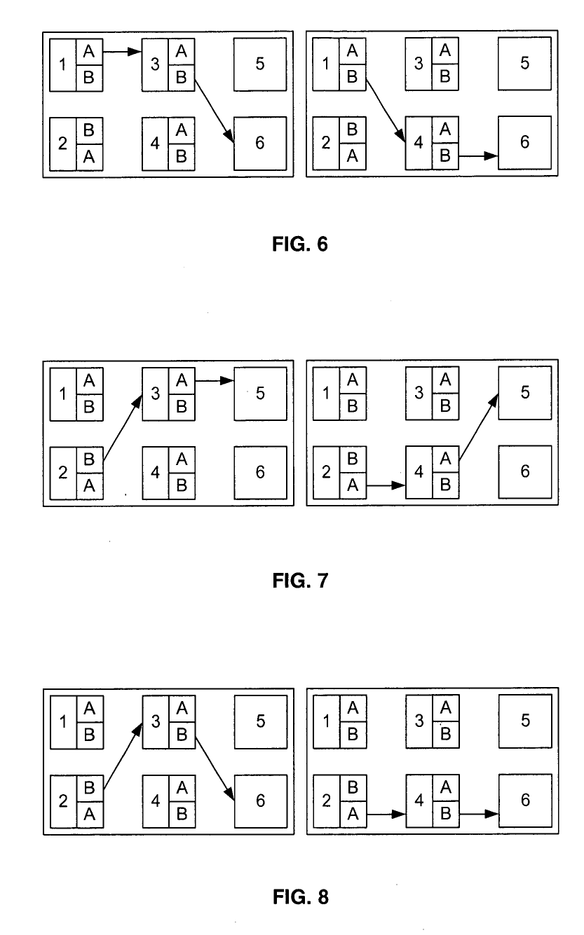

For each first stage switch matrix unit (switch matrix units #1 and #2), there are two possible pathways to an output port on one of the third stage switch matrix units (switch matrix units #5 and #6). One of the possible pathways is designated as a preferred pathway and the other pathway is designated as an alternate pathway. The determination of which is preferred and which is the alternate is not critical to practicing the invention. FIG. 5 illustrates the possible pathways for a signal entering switch matrix unit #1 and exiting switch matrix unit #5. FIG. 6 illustrates the possible pathways for a signal entering switch matrix unit #1 and exiting switch matrix unit #6. FIG. 7 illustrates the possible pathways for a signal entering switch matrix unit #2 and exiting switch matrix unit #5. FIG. 8 illustrates the possible pathways a signal entering switch matrix unit #2 and exiting switch matrix unit #6. FIG. 12 illustrates examples of the preferred and alternate pathways for normal connections in the exemplary switch matrix system.

Broadcast connections are connections within switch matrix subsystem 100 wherein multiple outputs are connected to a single input. With a broadcast connection, a signal enters the switch matrix subsystem 100 on a single input port on either switch matrix unit #1 or #2 and exits the switch matrix on multiple output ports on both switch matrix units #5 and #6.

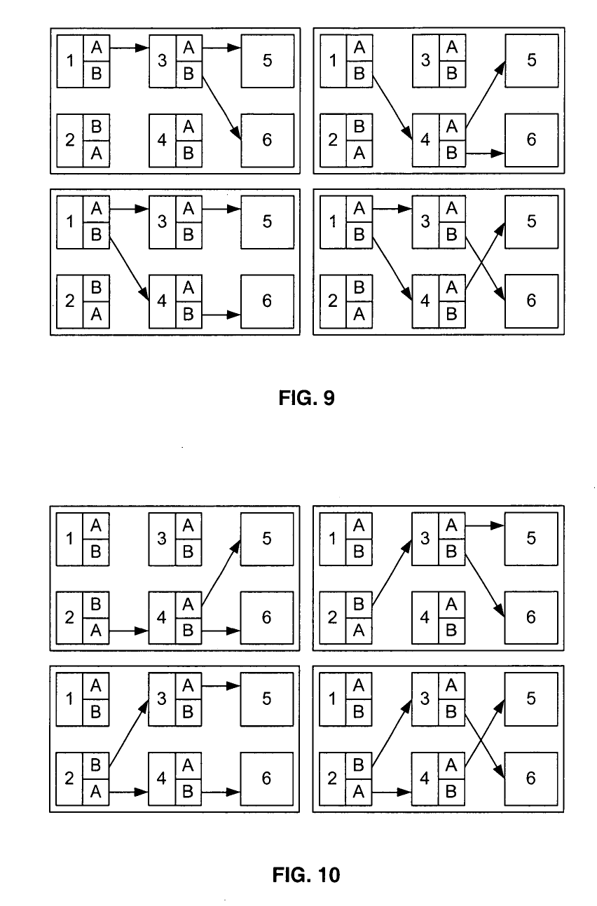

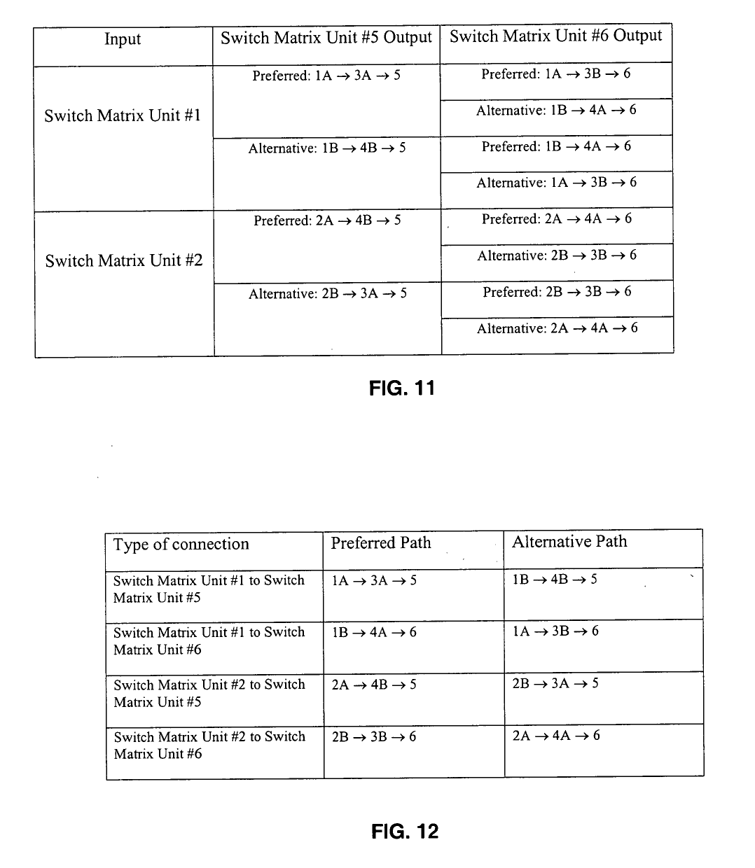

With a broadcast connection, there are four possible pathways from a first stage switch matrix unit to an output port on each of the third stage switch matrix units. One of the possible pathways to each third stage switch matrix unit (two total pathways) is designated as a preferred pathway and the other pathway is designated as an alternate pathway. FIG. 9 illustrates examples of all possible pathways for a signal entering switch matrix unit #1 and exiting switch matrix units #5 and #6. FIG. 10 illustrates examples of all possible pathways for a signal entering switch matrix unit #2 and exiting switch matrix units #5 and #6. FIG. 11 illustrates the preferred and alternate pathways for the broadcast connections.

To compute the output vector OUT[ ][ ], the following general principals can be followed. First, each new connection of an input port from a first stage switch matrix unit to an output port of a third stage switch matrix unit is established using the next available path in the proper output set in a switch matrix unit. When the output vector OUT[ ][ ] is empty, broadcast connections are computed before normal connections. A counter is associated with each output set. This counter is used to retrieve the next available output port and to determine if the associated output set is filled with connections. Initially, the counter starts with a value of 0. It is incremented each time a new connection is established that uses an output port in its output set. For example, assuming each of switch matrix units nos. 1-4 has two output sets with 512 output ports in each output sets, there would be a counter associated with output set A of switch matrix unit #1 that can be incremented from 0 to 512. Each time a connection was made using an output port in this output set, the counter would be incremented. When the counter reached the value of 512, no more connections could be made using an output port in this output set.

With normal connections, the following procedure can be followed. For a desired connection between an input port and an output port of switch matrix subsystem 100, one would first determine the overall pathway for the connection. If, for example, it was desired that a connection between an input port on switch matrix unit #1 to a port on switch matrix unit #5 be established, one would first check to determine if the preferred pathway was available. As shown in FIG. 5, the preferred pathway would traverse output set 1A (output set A of switch matrix unit #1) to output set 3A (output set A of switch matrix unit #3) to switch matrix unit #5. Therefore, the counters associated with output set 1A and output set 3A would be checked to determine if there are available ports. If there are available ports within both output set 1A and output set 3A, then specific channels can be established for providing the connection. For purposes of this discussion, a channel is a connection of a switch matrix unit input port to a switch matrix unit output port associated with the same switch unit. In this example, a channel would be established by mapping an input port on switch matrix unit #1 to the next available output port in output set 1A, and a channel would be established by mapping the input port on switch matrix unit #3 that is connected to that output set 1A output port that was selected to the next available output port in output set 3A. The counters associated with output sets 1A and 3A would be incremented. The input port on switch matrix unit #5 that is connected to the selected output set 3A output port would then be mapped to the desired output port of switch matrix subsystem 100 to complete the mapping. Appropriate entries in the output vector OUT[ ][ ] would be made to reflect the selected channels. The output vector OUT[ ][ ] could be used to program the switch matrix units to effect the mapping.

The switch matrix subsystem 100 may have various types of switch matrix unit programming to cause the switch matrix units to make these internal connections. The programming may comprise instructions stored in memory, binary values that the switch matrix units can act on, software code, programmable circuit elements such as ASICs, field programmable logic arrays, other logic arrays, or other structures for causing the switch matrix units to make various internal connections. The instructions, binary values, software code, etc. may be stored in memory devices such as read only memories (“ROMs”) or random access memories (“RAMs”).

If there are no available ports in either output set 1A or output set 3A, then the alternate pathway would be chosen. In this case, the counters associated with output set 1B and output set 4B would be checked to determine if there are available ports. If there are available ports within both output set 1B and output set 4B, then a channel would be established by mapping the input port on switch matrix unit #1 to the next available output port in output set 1B and a channel would be established by mapping the input port on switch matrix unit #4 that is connected to the selected output set 1B output port to the next available output port in output set 4B. The counters associated with output sets 1B and 4B would be incremented. Another channel would be established by mapping the input port on switch matrix unit #5 that is connected to the selected output set 4B output port would then be mapped to the desired output port of switch matrix subsystem 100 to complete the mapping case. Appropriate entries in the output vector OUT[ ][ ] would be made to reflect the selected channels. The output vector OUT[ ][ ] could be used to program the switch matrix units to effect the mapping.

For broadcast connections, the following steps could be applied. For each desired broadcast connection, there will be a connection from either switch matrix unit #1 or switch matrix unit #2 to BOTH switch matrix unit #5 and switch matrix unit #6. Separate that broadcast connection request into two connection requests, one from the input port on switch matrix unit #1 (for example) to the desired output port on switch matrix unit #5 and one from the same input port on switch matrix unit #1 to the desired output port on switch matrix unit #6. Beginning with the first connection request and with reference to the preferred and alternate pathways illustrated in FIG. 12, check the values of the appropriate counters associated with the output sets to determine the pathways having available channels between switch matrix unit #1 and switch matrix unit #5 using the preferred pathways if possible. Then, check the values of the appropriate counters associated with the output sets to determine the pathway having available channels between switch matrix unit #1 and switch matrix unit #6 using the preferred pathways if possible. NOTE: It is possible that you may have to use the alternate path for the first connection but can then get a preferred path for the second connection. Establish channels by select as the next available ports for both connection requests, increment the affected counters, and update the output vector OUT[ ][ ] to reflect the chosen channels.

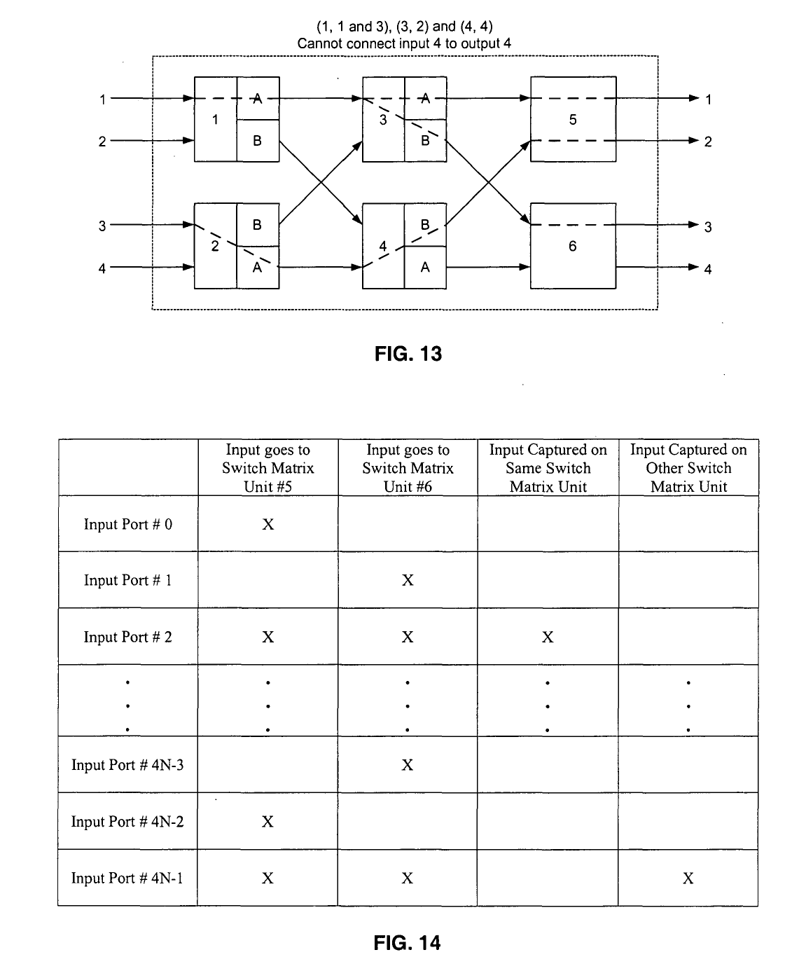

There are some scenarios wherein the steps described above cannot converge to a solution when there are signals present that are broadcasted to multiple output ports, as illustrated in FIG. 13. In this example, each switch matrix unit has two inputs and two outputs. If you broadcast from input 1 to output 1 and output 3 and make a normal connection from input 3 to output 2, then a normal connection from input 4 to output 4 cannot be made. The limitations that occur when broadcast connections are made are accounted for with the mapping algorithms described below.

First Exemplary Mapping Algorithm

Following are a number of propositions that form the basis for the exemplary mapping algorithms described below.

Proposition 1: For an individual switch matrix unit, exact input port numbers can be abstracted and the exact output port numbers can be abstracted as long as the capacity of 2N signals between different switch matrix unit is respected.

Individually, each switch matrix unit is a square matrix. Any input port can be connected to any one or more output ports. Thus, the order of the signals entering one switch matrix unit is not important and can be abstracted. For example, on the first switch matrix unit with input connections from 0 to 2N−1, a first signal enters input port i of the switch matrix unit wherein 0≦i≦2N and exits to output port p of the switch matrix unit wherein 0≦p≦2N. A second signal enters input port j of the switch matrix unit wherein 0≦j≦2N and exits to output port q of the switch matrix unit wherein 0≦q≦2N. Assuming i<j, it can be shown that i and j are interchangeable. Because it is possible to connect any input to any output in an individual switch matrix unit, all the following connections are valid: i to p, j to q, i to q and j to p. Therefore, if the first signal entered in input port j instead of i, it could also be outputted to port p. Also, if the second signal entered in input port i instead of j, it could also be outputted to port q.

Using Proposition 1, in the exemplary system, a signal enters switch matrix unit #1 (an entry switch matrix unit) and exits either to switch matrix unit #5 (an exit switch matrix unit) or switch matrix unit #6 (an exit switch matrix unit) or both (in the case of multicast signals). In the same way, a signal enters switch matrix unit #2 (an entry switch matrix unit) and exits either to switch matrix unit #5 or switch matrix unit #6 or both.

As a result, the following different pathways are proposed:

switch matrix unit #1 to switch matrix unit #5;

switch matrix unit #1 to switch matrix unit #6;

switch matrix unit #1 to switch matrix unit #5 and switch matrix unit #6;

switch matrix unit #2 to switch matrix unit #5;

switch matrix unit #2 to switch matrix unit #6; and

switch matrix unit #2 to switch matrix unit #5 and switch matrix unit #6.

Proposition 2: A signal entering an input port of an switch matrix unit will be multi-casted to the next switch matrix unit only once per next switch matrix unit.

There cannot be more than 2N signals outputted from a switch matrix unit. A single signal entering on an input port of a switch matrix unit can thus be multi-casted to as many output ports of that switch matrix unit as needed. Having one single signal enter a switch matrix unit and be multi-casted to many output ports is equivalent to having multiple copies of the input signal on many input ports outputted to the same output ports. Since having many copies of the same input signal entering the switch matrix unit consumes capacity between switch matrix units, with no loss of generality, the system should be restricted to having a single copy of each signal entering each switch matrix unit.

The proposition does not apply to switch matrix units #5 and #6 in this example. In fact, by observing the Proposition 2, it is preferred that most of the multi-casting will be performed in switch matrix unit #5 and switch matrix unit #6. That is because the spare resources of connections between switch matrix units is preserved by Proposition 2 until the signal reaches it final destination (switch matrix unit #5 or switch matrix unit #6) where it can be multi-casted without any constraints.

Proposition 3: A signal going from switch matrix unit #1 uniquely to switch matrix unit #5 will not be multi-casted. A signal going from switch matrix unit #1 uniquely to switch matrix unit #6 will not be multi-casted. A signal going from switch matrix unit #2 uniquely to switch matrix unit #5 will not be multi-casted. A signal going from switch matrix unit #2 uniquely to switch matrix unit #6 will not be multi-casted. A signal going from switch matrix unit #1 to switch matrix unit #5 and switch matrix unit #6 will be multi-casted once only in either switch matrix unit #1, switch matrix unit #3, or switch matrix unit #4. A signal going from switch matrix unit #2 to switch matrix unit #5 and switch matrix unit#6 will be multi-casted once only in either switch matrix unit #2, switch matrix unit #3 or switch matrix unit #4.

Proposition 4: Each multi-casted signal leaves exactly one unused input port for either switch matrix unit #1 or switch matrix unit #2.

The number of output ports in this example is the number of output ports of switch matrix unit #5 added to the number of output ports of switch matrix unit #6 (4N in this example). The number of input ports in this example is also 4N. If a single signal entering an input port is output to k output ports, then there are only 4N−k output ports available for other signals. Since an output port cannot receive the signal of more than one input port, only 4N−k input ports can be used. The number of unused input ports in that case will be k−1. The mapping algorithm takes into account the exact number of unused input ports on switch matrix unit #1 and #2 (in the previous example: k−1).

Proposition 5: For one signal from switch matrix unit #1 to switch matrix unit #5 and switch matrix unit #6, if there is an unused input port on switch matrix unit #1 then the number of unused input ports on switch matrix unit #1 must be decremented by one and the connection from switch matrix unit #1 to switch matrix unit #5 and switch matrix unit #6 can be substituted by two connections: one from switch matrix unit #1 to switch matrix unit #5 and one from switch matrix unit #1 to switch matrix unit #6. Also, for one signal from switch matrix unit #2 to switch matrix unit #5 and switch matrix unit #6, if there is an unused input port on switch matrix unit #2 then the number of unused input ports on switch matrix unit #2 must be decremented by one and the connection from switch matrix unit #2 to switch matrix unit #5 and switch matrix unit #6 can be substituted by two connections: one from switch matrix unit #2 to switch matrix unit #5 and one from switch matrix unit #2 to switch matrix unit #6.

When there is an unused input port available on the same entry switch matrix unit, there are four possible substitutions for a connection from switch matrix unit #1 to switch matrix unit #5 and switch matrix unit #6. Each substitution is composed of two connections: one from switch matrix unit #1 to switch matrix unit #5 and one from switch matrix unit #1 to switch matrix unit #6. The same is true for connections originating from switch matrix unit #2.

Proposition 6: For one signal from switch matrix unit #1 to switch matrix unit #5 and switch matrix unit #6, if there is no unused input port on switch matrix unit #1 then there is one on switch matrix unit #2. In that case, an unused input port on switch matrix unit #2 is “captured” and the number of unused input ports on switch matrix unit #2 has to be decremented by one and the connection from switch matrix unit #1 to switch matrix unit #5 and switch matrix unit #6 is substituted by two possible connections from switch matrix unit #1 and switch matrix unit #2 to switch matrix unit #5 and switch matrix unit #6. Also, for one signal from switch matrix unit #2 to switch matrix unit #5 and switch matrix unit #6, if there is no unused input port on switch matrix unit #2 then there is one on switch matrix unit #1. In that case, an unused input port on switch matrix unit #1 is “captured” and the number of unused input ports on switch matrix unit #1 has to be decremented by one and the connection from switch matrix unit #2 to switch matrix unit #5 and switch matrix unit #6 is substituted by two possible connections from switch matrix unit #1 and switch matrix unit #2 to switch matrix unit #5 and switch matrix unit #6.

When there is no unused input port available on the same entry switch matrix unit as origin, there are two possible substitutions for a connection from switch matrix unit #1 to switch matrix unit #5 and switch matrix unit #6. Each substitution is composed of a valid combination (not rejected) of two connections: one from switch matrix unit #1 to switch matrix unit #5 and one from switch matrix unit #2 to switch matrix unit #6 (a rejected combination is one in which the two connections do not meet in switch matrix unit #3 or switch matrix unit #4). The same is true for connections originating from switch matrix unit #2.

Thus, the following variables are used for the algorithm:

c₁₅: Quantity of signals entering switch matrix unit #1 and outputting to switch matrix unit #5 uniquely (each signal can take two possible paths);

c₁₆: Quantity of signals entering switch matrix unit #1 and outputting to switch matrix unit #6 uniquely (each signal can take two possible paths);

c₂₅: Quantity of signals entering switch matrix unit #2 and outputting to switch matrix unit #5 uniquely (each signal can take two possible paths);

c₂₆: Quantity of signals entering switch matrix unit #2 and outputting to switch matrix unit #6 uniquely (each signal can take two possible paths); and

cₛₚ: Quantity of signals entering switch matrix unit #1 and outputting to switch matrix unit #5 and switch matrix unit #6 when no unused input port can be “captured” on the same switch matrix unit—OR—Signals entering switch matrix unit #2 and outputting to switch matrix unit #5 and switch matrix unit #6 when no unused input port can be “captured” on the same switch matrix unit (each signal can take two possible paths).

Note that the quantity of signals entering switch matrix unit #1 and outputting to switch matrix unit #5 and switch matrix unit #6 when an unused input port can be “captured” on the same switch matrix unit actually counts as 1 inside c₁₅ and also as 1 inside c₁₆. Also, the quantity of signals entering switch matrix unit #2 and outputting to switch matrix unit #5 and switch matrix unit #6 when unused input port can be “captured” on the same switch matrix unit actually counts as 1 inside c₂₅ and also as 1 inside c₂₆.

Proposition 7: The following four inequations determine an upper bound for values c₁₅, c₁₆, c₂₅, c₂₆, cₛₚ. The inequations represent the capacity (traces) between all switch matrix units. All signals leaving the switch matrix unit #1 are counted either in c₁₅, c₁₆ or cₛₚ. Since the capacity of all arcs leaving the switch matrix unit #1 is bounded by N+N, then the equation (1) is correct. Also, all signals leaving the switch matrix unit #2 are counted either in c₂₅, c₂₆ or cₛₚ. Again, since the capacity of all arcs leaving the switch matrix unit #2 is bounded by N+N, then the equation (2) is correct. The proof is valid also for the capacities of arcs arriving to switch matrix unit #5 and switch matrix unit #6 so equations (3) and (4) are correct.

c₁₅+c₁₆+cₛₚ≦2N (1)

c₂₅+c₂₆+cₛₚ≦2N (2)

c₁₅+c₂₅+cₛₚ≦2N (3)

c₁₆+c₂₆+cₛₚ≦2N (4)

Proposition 8: The following inequations are equivalent.

$$\begin{matrix}{c}_{15} + {c}_{16} + {c}_{sp} \leq 2 N ⇔ \frac{{c}_{15}}{2} + \frac{{c}_{16}}{2} + \frac{{c}_{sp}}{2} \leq N & ( 5 ) \\ {c}_{25} + {c}_{26} + {c}_{sp} \leq 2 N ⇔ \frac{{c}_{25}}{2} + \frac{{c}_{26}}{2} + \frac{{c}_{sp}}{2} \leq N & ( 6 ) \\ {c}_{15} + {c}_{25} + {c}_{sp} \leq 2 N ⇔ \frac{{c}_{15}}{2} + \frac{{c}_{25}}{2} + \frac{{c}_{sp}}{2} \leq N & ( 7 ) \\ {c}_{16} + {c}_{26} + {c}_{sp} \leq 2 N ⇔ \frac{{c}_{16}}{2} + \frac{{c}_{26}}{2} + \frac{{c}_{sp}}{2} \leq N & ( 8 )\end{matrix}$$

As explained earlier, for each category of possible different paths, there are two possible paths for each signal. So, a solution for the problem is to find how much of each of the two possible paths to use for each of the category of paths.

Propose a solution using exactly the possible paths in the same quantity. The solution is expressed by:

$$\frac{{c}_{15}}{2}$$

signals entering switch matrix unit #1 passing through switch matrix unit #3 and outputting to switch matrix unit #5 uniquely, and

$$\frac{{c}_{15}}{2}$$

signals entering switch matrix unit #1 passing through switch matrix unit #4 and outputting to switch matrix unit #5 uniquely;

$$\frac{{c}_{16}}{2}$$

signals entering switch matrix unit #1 passing through switch matrix unit #3 and outputting to switch matrix unit #6 uniquely, and

$$\frac{{c}_{16}}{2}$$

signals entering switch matrix unit #1 passing through switch matrix unit #4 and outputting to switch matrix unit #6 uniquely;

$$\frac{{c}_{25}}{2}$$

signals entering switch matrix unit #2 passing through switch matrix unit #3 and outputting to switch matrix unit #5 uniquely, and

$$\frac{{c}_{25}}{2}$$

signals entering switch matrix unit #2 passing through switch matrix unit #4 and outputting to switch matrix unit #5 uniquely;

$$\frac{{c}_{26}}{2}$$

signals entering switch matrix unit #2 passing through switch matrix unit #3 and outputting to switch matrix unit #6 uniquely, and

$$\frac{{c}_{26}}{2}$$

signals entering switch matrix unit #2 passing through switch matrix unit #4 and outputting to switch matrix unit #6 uniquely; and

$$\frac{{c}_{sp}}{2}$$

signals entering switch matrix unit #1 and switch matrix unit #2 and outputting to switch matrix unit #5 and switch matrix unit #6 both passing through switch matrix unit #3, and

$$\frac{{c}_{sp}}{2}$$

signals entering switch matrix unit #1 and switch matrix unit #2 and outputting to switch matrix unit #5 and switch matrix unit #6 both passing through switch matrix unit #4.

For the proposed solution, compute the arc consumption between the switch matrix units.

Between switch matrix unit #1 and switch matrix unit #3:

$$\frac{{c}_{15}}{2} + \frac{{c}_{16}}{2} + \frac{{c}_{sp}}{2}$$

Between switch matrix unit #1 and switch matrix unit #4:

$$\frac{{c}_{15}}{2} + \frac{{c}_{16}}{2} + \frac{{c}_{sp}}{2}$$

Between switch matrix unit #2 and switch matrix unit #3:

$$\frac{{c}_{25}}{2} + \frac{{c}_{26}}{2} + \frac{{c}_{sp}}{2}$$

Between switch matrix unit #2 and switch matrix unit #4:

$$\frac{{c}_{25}}{2} + \frac{{c}_{26}}{2} + \frac{{c}_{sp}}{2}$$

Between switch matrix unit #3 and switch matrix unit #5:

$$\frac{{c}_{15}}{2} + \frac{{c}_{25}}{2} + \frac{{c}_{sp}}{2}$$

Between switch matrix unit #3 and switch matrix unit #6:

$$\frac{{c}_{16}}{2} + \frac{{c}_{26}}{2} + \frac{{c}_{sp}}{2}$$

Between switch matrix unit #4 and switch matrix unit #5:

$$\frac{{c}_{15}}{2} + \frac{{c}_{25}}{2} + \frac{{c}_{sp}}{2}$$

Between switch matrix unit #4 and switch matrix unit #6:

$$\frac{{c}_{16}}{2} + \frac{{c}_{26}}{2} + \frac{{c}_{sp}}{2}$$

Since all the previous sums can be recognized as either equation (5), (6), (7) or (8), then the proposed solution does not violate the constraints on sparse resources: capacity between switch matrix unit.

Note: In case of odd numbers, build a solution using integer values only and solve the last choices by enumeration which is strictly inferior to 2**5=32.

So, for that proposed solution, by using Proposition 8, the proposed solution is qualified as valid.

From the previous propositions, various algorithms can produce a solution for any input in a very short, deterministic and finite time.

High Level Algorithm

A brief description of the first exemplary algorithm follows.

1) Create a new table NEW_OUT[ ] of size 4N of and which will characterize each input port (each index in the table identifies the corresponding input port). An example is illustrated at FIG. 14. Each entry in that table has four fields:

Boolean ‘InputGoesToSwithMatrixUnit#5’,

Boolean ‘InputGoesToSwithMatrixUnit#6’,

Boolean ‘InputCapturedAnUnusedOnSametSwithMatrixUnit’ and

Boolean ‘InputCapturedAnUnusedOnOtherSwithMatrixUnit’.

(Default: False for all values)

2) For each output port i, get the input port j=IN[i]. If output port i is part of switch matrix unit #5, then write OUT[j.][‘InputGoesToSwitchMatrixUnit#5’]=true or if output port i is part of switch matrix unit #6, then write OUT[j][‘InputGoesToSwitchMatrixUnit#6’]=true.

3) When that is done, compute the quantity of unused input ports in switch matrix unit #1 and switch matrix unit #2 and store those values in ‘UnusedlnputPortSwithMatrixUnit#1’ and ‘UnusedInputPortSwithMatrixUnit#2’, respectively. The unused input ports are easy to identify, they have false values at both ‘InputGoesToSwitchMatrixUnit#5’ and ‘InputGoesToSwitchMatrixUnit#6’.

4) For each switch matrix unit a, for each input port j, if the input port j has both ‘InputGoesToSwitchMatrixUnit#5’ and ‘InputGoesToSwithMatrixUnit#6’ set to true and the ‘UnusedlnputPortSwithMatrixUnit#a’ is not zero, then write OUT[j][‘InputCapturedAnUnusedOnSameSwithMatrixUnit’]=true and decrement ‘UnusedlnputPortSwithMatrixUnit#a’. Else, write OUT[j][‘InputCapturedAnUnusedOnOtherSwithMatrixUnit’]=true and decrement the other ‘UnusedlnputPortSwithMatrixUnit#x’. Note: there should always be enough unused inputs. If not, it is an error caused by invalid data. See previous Propositions.

5) Compute values for c₁₅, c₁₆, c₂₅, c₂₆, cₛₚ following the rules in the preceding subsections.

6) A valid solution exists using a factor ½ as describe earlier. For each output in IN[ ] table, identify category in OUT[ ] table and choose correct path to preserve the ½ factor of the solution (recall that many outputs share common inputs).

Accordingly, this algorithm is executed in linear time. Thus, a solution is provided to the routing of signals on a digital cross-connect product using fewer hardware components.

A more detailed statement of the first exemplary algorithm follows.

Step 0: Retrieve IN[ ] array of size 4N where 2N is equal to the number of ports on a single switch matrix unit. The index position of the array represents the input port number of the first stage switch matrix units. The first half of the array (indexes 0 to 2N−1) represents input ports on switch matrix unit #1. The second half of the array (indexes 2N to 4N−1) represents input ports on switch matrix unit #2.

Possible values for each field are integers ranging from 0 to 4N−1. These values represent destination ports on switch matrix unit #5 or switch matrix unit #6. Values from 0 to 2N−1 represent ports on switch matrix unit #5 and values from 2N to 4N−1 represent ports on switch matrix unit #6.

(1) Values from 0 to 4N−1—input port address.

(2) Value of 4N—UNEQ-P condition (unequipped).

(3) Value of 4N+1—AIS-P condition (alarm signal)

Step 1: Create a two dimensional OUT[ ][ ] array. The first dimension has a size M equal to the number of switch matrix units. The first dimension, as a row representation, will correspond to the switch matrix unit of the first index value+1. (NOTE: Index values range from 0 to M−1 where M is the number of switch matrix units. Because our numbering conventions differ for position values which start at 0 and for switch matrix units which begin at one, the corresponding switch matrix unit number is M=1.)

Columns are represented by the second dimension of the array which is of size 2N where N is equal to the number of ports on one-half of an switch matrix unit. The second dimension index position of the array represents the output port number of the switch matrix unit. Possible values for each field are integers ranging from 0 to 2N−1. These values represent input ports on the switch matrix unit.

NOTE: Because each first and second stage switch matrix unit has two output sets that are each connected to a different switch matrix unit (e.g., switch matrix unit #1 has output set A and output set B—output set A is connected to switch matrix unit #3 and output set B is connected to switch matrix unit #4), any first or second stage switch matrix unit can have at most N connections to a single switch matrix unit in a succeeding stage.

Ideally, all multicasting takes place in the third stage switch matrix units (switch matrix unit #5 or switch matrix unit #6) because multicasting in the third stage does not consume scarce resources between switch matrix units. This is possible where a signal from a first stage switch matrix unit is destined for only one of the third stage switch matrix units. When a signal from a first stage switch matrix unit is destined for both of the third stage switch matrix units, multicasting must take place in either the second stage (preferred) or the first stage (only if necessary). For further discussion, a signal is referred to as multicasted if multicasting takes place in the first or second stages. Signals that are not multicasted until the third stage are treated as unicasts.

Step 2: Define pathways and calculate capacities for signal travel.

Example: Let c15 be the set of signals between switch matrix unit #1 and switch matrix unit #5. Let c16 be the set of signals between switch matrix unit #1 and switch matrix unit #6. Let c₂₅ be the set of signals between switch matrix unit #2 and switch matrix unit #5. Let c_{SP} be the set of signals between switch matrix unit #1 and both switch matrix unit #5 and switch matrix unit #6. AND the set of signals between switch matrix unit #2 and both switch matrix unit #5 and switch matrix unit #6. Because of the system constraints, there is a maximum of 2N signals in the matrix at any time.

Create a new array called NEW_OUT[ ] of size 4N. Each index value of NEW_OUT[ ] corresponds to an input port on switch matrix unit #1 or switch matrix unit #2. The first half of the array (indexes 0 to 2N−1) represents input ports on switch matrix unit #1. The second half of the array (indexes 2N to 4N−1) represents input ports on switch matrix unit #2. Each index entry is a 4-tuple that serves to characterize the signal on the corresponding port.

Example: If each switch matrix unit has 2N ports, and there are 2 first-stage switch matrix units, ports can be identified by sequentially numbering each port on both switch matrix units #1 and #2 by assigning numbers ranging from 0 to 4N−1. Therefore, the NEW_OUT[ ] array will have 4N−1 rows.

Item 1 of the 4-tuple is named InputGoesToSwitchMatrixUnit#5.

Item 2 is named InputGoesToSwitchMatrixUnit#6.

Item 3 is named InputCapturedAnUnusedOnSameSwitchMatrixUnit.

Item 4 is named InputCapturedAnUnusedOnOtherSwitchMatrixUnit.

Each index entry is a Boolean value and is set FALSE by default. The field can be implemented by assigning a nibble (4 bits=½ byte) and setting individual bits in the nibble.

Step 3: Populate the NEW_OUT[ ] array with values representing characteristics of the signals entering the first stage switch matrix units.

Example: Each output port has a corresponding input port. An IN[ ] array maps input and output ports. If the output port for the corresponding input port is on one of the 3rd stage switch matrix units, then in the position of the NEW_OUT[ ] table that corresponds to the input port being examined, set either InputGoesToSwitchMatrixUnit#5 or InputGoesToSwitchMatrixUnit#6 to TRUE. Perform this examination for all input ports until the NEW_OUT[ ] table is completely populated.

Step 4: Create counter variables to track the number of unused input ports on each first stage switch matrix unit.

Example: Integer variable UnusedInputPortSwitchMatrixUnit#1 contains the total number of unused input ports on switch matrix unit #1. Integer variable UnusedlnputPortSwitchMatrixUnit#2 contains the total number of unused input ports on switch matrix unit #2.

Step 5: Compute the number of unused input ports and store values.

Example: Scan through the NEW_OUT[ ] array. Unused ports are those corresponding to rows where entries in the 4-tuple for InputGoesToSwitchMatrixUnit#5 and InputGoesToSwitchMatrixUnit#6 are FALSE. Rows in the top one-half of the array are associated with switch matrix unit #1 and the total number of entries in the top half where both InputGoesToSwitchMatrixUnit#5 and InputGoesToSwitchMatrixUnit#6 columns are FALSE are counted and the resulting value stored in integer variable UnusedlnputPortSwitchMatrixUnit#1.

Rows in the bottom one-half of the array are associated with switch matrix unit #2 and the total number of entries in the bottom half where both InputGoesToSwitchMatrixUnit#5 and InputGoesToSwitchMatrixUnit#6 columns are FALSE are counted and the resulting value stored in integer variable UnusedInputPortSwitchMatrixUnit#2.

Step 6: Compute routing paths through the switch matrix units based upon port availability, preferred routes through the switch matrix units, and the stage in which multicasted signals will be generated, giving preference to multicasted signals with preference for multicasting in the second stage of switch matrix units (switch matrix unit #3 or switch matrix unit #4) over multicasting in the first stage of switch matrix units (switch matrix unit #1 or switch matrix unit #2), computing the number of input ports that have been “captured” because of multicasting and adjusting the count of available ports accordingly.

Perform multiple passes through the array to compute connections for each subset of connection types within the set of all connections. Subsets include c15 (unicast from switch matrix unit #1 to switch matrix unit #5), c16 (unicast from switch matrix unit #1 to switch matrix unit #6), c25 (unicast from switch matrix unit #2 to switch matrix unit #5), c26 (unicast from switch matrix unit #2 to switch matrix unit #6), and cSP (multicasts from either switch matrix unit #1 or switch matrix unit #2 to both switch matrix unit #5 and switch matrix unit #6). Preferably, multicast connections are computed before unicast connections.

Example: To compute connection routes for c_{SP}, scan through the NEW_OUT[ ] array looking for 4-tuple entries where both InputGoesToSwitchMatrixUnit#5 and InputGoesToSwitchMatrixUnit#6 are set to TRUE. These entries indicate that the signal entering the port is being multicasted. Account for multicasting operations and calculate port availability.

For each first stage switch matrix unit (#1 and #2),

IF the input signal is being multicasted (InputGoesToSwitchMatrixUnit#5 and InputGoesToSwitchMatrixUnit#6 are set to TRUE) AND there is at least one available input port on the switch matrix unit being examined (UnusedlnputPortSwitchMatrixUnit#1 for switch matrix unit #1 or UnusedlnputPortSwitchMatrixUnit#2 for switch matrix unit #2 is a nonzero value),

THEN

(a) in the appropriate 4-tuple of the NEW_OUT[ ] array, set the value of the InputCapturedAnUnusedOnSameSwitchMatrixUnit equal to TRUE; AND

(b) IF sufficient ports are available along the signal's preferred path, add the port identifiers of the next available ports on each switch matrix unit given by the associated counters for each switch matrix unit to the route for the signal, ELSE IF sufficient ports are available along the signal's alternate path, add the port identifiers of the next available ports on each switch matrix unit to the route for the signal, ELSE IF insufficient ports are available, return an error code (NOTE—due to the constraints on the system, this last even should never occur); AND

(c) decrement the value of either InusedlnputPortSwitchMatrixUnit#1 for 4-tuples in the top one half of the table or UnusedlnputPortSwitchMatrixUnit#2 for 4-tuples in the bottom one-half of the table; AND

(d) increment the associated counters for each switch matrix unit accordingly to reflect the next available port on each switch matrix unit. Alternately, the next available port number can be computed by subtracting the value of the UnusedlnputPortSwitchMatrixUnit#x from a constant value representing the total number of input ports on each switch matrix unit.

ELSE

(a) in the appropriate 4-tuple of the NEW_OUT[ ] array set the value of the InputCapturedAnUnusedOnOtherSwitchMatrixUnit equal to TRUE; AND

(b) IF sufficient ports are available along the signal's preferred path, add the port identifiers of the next available ports on each switch matrix unit given by the associated counters for each switch matrix unit to the route for the signal, ELSE IF sufficient ports are available along the signal's alternate path, add the port identifiers of the next available ports on each switch matrix unit to the route for the signal, ELSE IF insufficient ports are available, return an error code (NOTE—due to the constraints on the system, this last even should never occur); AND

(c) decrement the value of either

UnusedlnputPortSwitchMatrixUnit#1 for 4-tuples in the top one half of the table or UnusedInputPortSwitchMatrixUnit#2 for 4-tuples in the bottom one-half of the table; AND

(d) increment the associated counters for each switch matrix unit accordingly to reflect the next available port on each switch matrix unit. Alternately, the next available port number can be computed by subtracting the value of the

UnusedlnputPortSwitchMatrixUnit#x from a constant value representing the total number of input ports on each switch matrix unit.

Step 7: Repeat passes to calculate unicast specific channels, using pre-established connection routes for multicast signals and deleting segments of multicast connections unused by the unicast signal.

Second Exemplary Mapping Algorithm

In the following section, the dimension of the switch matrix unit is represented by N.

Globally, there are 6 types of connections from input to output.

1. C₁₅: Input from switch matrix unit #1, all outputs on switch matrix unit #5

2. C₁₆: Input from switch matrix unit #1, all outputs on switch matrix unit #6

3. C₂₅: Input from switch matrix unit #2, all outputs on switch matrix unit #5

4. C₂₆: Input from switch matrix unit #2, all outputs on switch matrix unit #6

5. C₁₅₆: Input from switch matrix unit #1, outputs to both switch matrix unit #5 and #6

6. C₂₅₆: Input from switch matrix unit #2, outputs to both switch matrix unit #5 and #6

An uppercase ‘C’ represents the group, while a lowercase ‘c’ represents the number of connection within that group.

Any connection can be categorized in one of the six groups. Note that when a connection exits multiple times on the same output switch matrix unit (#5 or #6), it is still considered as a simple connection since the multicast is performed by the output switch matrix unit (each switch matrix unit is a square matrix).

Each type of connection can be expressed by expanding the internal connection between the 6 switch matrix units giving the following sets of equations:

C₁₅=(C₁₃ & C₃₅)∪(C₁₄ & C₄₅)

C₁₆=(C₁₄ & C₄₆)∪(C₁₃ & C₃₆)

C₂₅=(C₂₄ & C₄₅)∪(C₂₃ & C₃₅)

C₂₆=(C₂₃ & C₃₆)∪(C₂₄ & C₄₆)

C₁₅₆=(C₁₃ & C₃₅ & C₃₆)∪(C₁₄ & C₄₅&C₄₆)∪[(C₁₄ & C₄₆)+(C₁₃ & C₃₅)]∪[(C₁₃ & C₃₆)+(C₁₄ & C₄₅)]

C₂₅₆=(C₂₃ & C₃₅ & C₃₆)∪(C₂₄ & C₄₅ & C₄₆)∪[(C₂₄ & C₄₆)+(C₂₃ & C₃₅)]∪[(C₂₃ & C₃₆)+(C₂₄ & C₄₅)]

### Equation Set 11

For the first 4 equations in equation set 11, there are two options for establishing the connection. For the last 2 equations, there are four options. But, the last 2 uses more connections and should be avoided whenever possible to facilitate convergence.

Looking globally at the connection entering/exiting a switch matrix unit, the following set of equations can be established:

| | |
|---|---|
| switch matrix unit #1 out: | c₁₅ + c₁₆ + c₁₅₆ ≦ N |
| switch matrix unit #2 out: | c₂₅ + c₂₆ + c₂₅₆ ≦ N |
| switch matrix unit #5 in: | c₁₅ + c₂₅ + c₁₅₆ + c₂₅₆ ≦ N |
| switch matrix unit #6 in: | c₁₆ + c₂₆ + c₁₅₆ + c₂₅₆ ≦ N |

Equation Set 12

For the first two equations, some connections of C₁₅₆ use simultaneously connections of C₁₃ and C₁₄. Thus, they count as two connections in c₁₅₆. These are the connections that were already indicated being connections to be avoided. By removing these connections, Equation set 11 simplifies to:

C₁₅=(C₁₃ & C₃₅)∪(C₁₄ & C₄₅)

C₁₆=(C₁₄ & C₄₆)∪(C₁₃ & C₃₆)

C₂₅=(C₂₄ & C₄₅)∪(C₂₃ & C₃₅)

C₂₆=(C₂₃ & C₃₆)∪(C₂₄ & C₄₆)

C₁₅₆=(C₁₃ & C₃₅ & C₃₆)∪(C₁₄ & C₄₅ & C₄₆)

C₂₅₆=(C₂₃ & C₃₅ & C₃₆)∪(C₂₄ & C₄₅ & C₄₆) Equation Set 13

Therefore, each type of connections has two given paths. Because of the physical connection of the exemplary switch matrix subsystem, it is clear that the maximum number of connection for any internal group is N/2 (i.e.

$${c}_{13} \leq \frac{N}{2} , {c}_{14} \leq \frac{N}{2} ,$$

etc.).

Algorithm

Because of the symmetry of Equation set 13, for each type of connection (C₁₅, C₁₆, C₂₅, C₂₆, C₁₅₆, C₂₅₆) if half of the connections are assigned to the first option and half to the second option, the physical constraints of the matrix given by Equation set 12 will be respected.

The idea of the algorithm is to minimize the usage of any segment by dividing the connections in exactly two halves. In order to do this, the algorithm uses six passes: one for each group.

This algorithm is therefore very similar to the prior algorithm with the following three modifications:

Modification 1: Six subsets of connections are recognized. C_{SP} is split into C₁₅₆ (all connections from switch matrix unit #1 to both switch matrix unit #5 and switch matrix unit #6) and C₂₅₆ (all connections from switch matrix unit #2 to both switch matrix unit #5 and switch matrix unit #6).

Modification 2: Because six subsets of connections are recognized, it is necessary to perform six passes through the NEW_OUT[ ] array to calculate the connections.

Modification 3: In Step 6, when assigning connections, paths are alternately selected between the preferred path and the alternate path.

Demonstration of Validity

In the following demonstration, it is assumed that each group has an even number of connections. That is c₁₅, c₁₆, c₂₅, c₂₆, c₁₅₆, c₂₅₆ are all even. Any odd value will be treated as an even value plus one remaining connection that needs to be processed at the end.

1) Initial Condition

At the beginning, no connection exists in the system. As a result, the capacity values are as follows:

c₁₃=0

c₁₄=0

c₂₃=0

c₂₄=0

c₃₅=0

c₃₆=0

c₄₅=0

c₄₆=0

C₁₅₆=(C₁₃ & C₃₅ & C₃₆)∪(C₁₄ & C₄₅ & C₄₆) 2)

Since all internal connections are cleared and the two options use mutually exclusive segments, we alternate between the two options. At the end of this iteration, we have

$$\begin{matrix}{c}_{13} = \frac{{c}_{156}}{2} \\ {c}_{14} = \frac{{c}_{156}}{2} \\ {c}_{23} = 0 \\ {c}_{24} = 0 \\ {c}_{35} = \frac{{c}_{156}}{2} \\ {c}_{36} = \frac{{c}_{156}}{2} \\ {c}_{45} = \frac{{c}_{156}}{2} \\ {c}_{46} = \frac{{c}_{156}}{2}\end{matrix}$$

C₂₅₆=(C₂₃ & C₃₅ & C₃₆)∪(C₂₄ & C₄₅ & C₄₆) 3)

At this point, c₂₃=c₂₄, c₃₅=c₄₅, c₃₆=c₄₆. Therefore, again, we are going to alternate between the two solutions. At the end of this iteration, we have:

$$\begin{matrix}{c}_{13} = \frac{{c}_{156}}{2} \\ {c}_{14} = \frac{{c}_{156}}{2} \\ {c}_{23} = \frac{{c}_{256}}{2} \\ {c}_{24} = \frac{{c}_{256}}{2} \\ {c}_{35} = \frac{{c}_{156} + {c}_{256}}{2} \\ {c}_{36} = \frac{{c}_{156} + {c}_{256}}{2} \\ {c}_{45} = \frac{{c}_{156} + {c}_{256}}{2} \\ {c}_{46} = \frac{{c}_{156} + {c}_{256}}{2}\end{matrix}$$

C₁₅=(C₁₃ & C₃₅)∪(C₁₄ & C₄₅) 4)

From the preceding equations, c₁₃=c₁₄, c₃₅=c₄₅. Again, we alternate between the two options. At the end of this iteration, we have:

$$\begin{matrix}{c}_{13} = \frac{{c}_{156} + {c}_{15}}{2} \\ {c}_{14} = \frac{{c}_{156} + {c}_{15}}{2} \\ {c}_{23} = \frac{{c}_{256}}{2} \\ {c}_{24} = \frac{{c}_{256}}{2} \\ {c}_{35} = \frac{{c}_{156} + {c}_{256} + {c}_{15}}{2} \\ {c}_{36} = \frac{{c}_{156} + {c}_{256}}{2} \\ {c}_{45} = \frac{{c}_{156} + {c}_{256} + {c}_{15}}{2} \\ {c}_{46} = \frac{{c}_{156} + {c}_{256}}{2}\end{matrix}$$

C₂₅=(C₂₄ & C₄₅)∪(C₂₃ & C₃₅) 5)

Looking at step 4, we see that c₂₄=c₂₃, c₄₅=C₃₅. We thus split equally between the two options. At the end of this iteration, we have:

$$\begin{matrix}{c}_{13} = \frac{{c}_{156} + {c}_{15}}{2} \\ {c}_{14} = \frac{{c}_{156} + {c}_{15}}{2} \\ {c}_{23} = \frac{{c}_{256} + {c}_{25}}{2} \\ {c}_{24} = \frac{{c}_{256} + {c}_{25}}{2} \\ {c}_{35} = \frac{{c}_{156} + {c}_{256} + {c}_{15} + {c}_{25}}{2} \\ {c}_{36} = \frac{{c}_{156} + {c}_{256}}{2} \\ {c}_{45} = \frac{{c}_{156} + {c}_{256} + {c}_{15} + {c}_{25}}{2} \\ {c}_{46} = \frac{{c}_{156} + {c}_{256}}{2}\end{matrix}$$

C₁₆=(C₁₄ & C₄₆)∪(C₁₃ & C₃₆) 6)

Again, from previous equations, c₁₄=c₁₃, c₄₆=c₃₆. At the end of this iteration, we have:

$$\begin{matrix}{c}_{13} = \frac{{c}_{156} + {c}_{15} + {c}_{16}}{2} \\ {c}_{14} = \frac{{c}_{156} + {c}_{15} + {c}_{16}}{2} \\ {c}_{23} = \frac{{c}_{256} + {c}_{25}}{2} \\ {c}_{24} = \frac{{c}_{256} + {c}_{25}}{2} \\ {c}_{35} = \frac{{c}_{156} + {c}_{256} + {c}_{15} + {c}_{25}}{2} \\ {c}_{36} = \frac{{c}_{156} + {c}_{256} + {c}_{16}}{2} \\ {c}_{45} = \frac{{c}_{156} + {c}_{256} + {c}_{15} + {c}_{25}}{2} \\ {c}_{46} = \frac{{c}_{156} + {c}_{256} + {c}_{16}}{2}\end{matrix}$$

C₂₆=(C₂₃ & C₃₆)∪(C₂₄ & C₄₆) 7)

From previous equations, c₂₃=c₂₄, c₃₆=c₄₆. Connections are going to be split equally. At the end of this iteration, we have:

$$\begin{matrix}{c}_{13} = \frac{{c}_{156} + {c}_{15} + {c}_{16}}{2} \\ {c}_{14} = \frac{{c}_{156} + {c}_{15} + {c}_{16}}{2} \\ {c}_{23} = \frac{{c}_{256} + {c}_{25} + {c}_{26}}{2} \\ {c}_{24} = \frac{{c}_{256} + {c}_{25} + {c}_{26}}{2} \\ {c}_{35} = \frac{{c}_{156} + {c}_{256} + {c}_{15} + {c}_{25}}{2} \\ {c}_{36} = \frac{{c}_{156} + {c}_{256} + {c}_{16} + {c}_{26}}{2} \\ {c}_{45} = \frac{{c}_{156} + {c}_{256} + {c}_{15} + {c}_{25}}{2} \\ {c}_{46} = \frac{{c}_{156} + {c}_{256} + {c}_{16} + {c}_{26}}{2}\end{matrix}$$

The latest system of equations respect Equation set 12, thus ensuring convergence of the algorithm. The preceding demonstration shows there should be six passes to ensure convergence. But the order in which the groups are processed is not important.

Conclusion

Other variations from these systems and methods should become apparent to one of ordinary skill in the art without departing from the scope of the invention defined by the claims. The embodiments described herein and shown in the drawings are examples of structures, systems, or methods having elements or steps corresponding to the elements or steps of the invention recited in the claims. This written description and drawings may enable those skilled in the art to make and use embodiments having alternative elements or steps that likewise correspond to the elements or steps of the invention recited in the claims. The intended scope of the invention thus includes other structures, systems, or methods that do not differ from the literal language of the claims, and further includes other structures, systems, or methods with insubstantial differences from the literal language of the claims.

The following is claimed:

1. A digital cross connect system, comprising:
a switch matrix subsystem comprising a plurality of switch matrix units in a CLOS arrangement in multiple stages, each switch matrix unit having a plurality of input ports and output ports, at least two of the switch matrix units having a number of their output ports uniquely connected to input ports on one of the switch matrix units in the next stage and having an equal number of their output ports uniquely connected to input ports on another of the switch matrix units in the next stage;
a plurality of subsystem input ports associated with the switch matrix subsystem;
a plurality of subsystem output ports associated with the switch matrix subsystem; and
switch matrix unit programming that instructs the switch matrix units to generate specific internal cross-connections that allow one or more input signals present at one or more subsystem input ports to be connected to one or more subsystem output ports.

2. The system of claim 1 wherein the switch matrix subsystem comprises a three-stage architecture having at least two switch matrix units in each stage.

3. The system of claim 2 wherein the inputs ports of the first stage switch matrix units are inputs ports for the switch matrix subsystem and the output ports of the third stage switch matrix units are output ports for the switch matrix subsystem, each first stage and second stage switch matrix unit having its output ports assigned to either an output set A or an output set B associated with that switch matrix unit, each output port in output set A of a switch matrix unit being uniquely coupled to an input port in one of the two switch matrix units in the next stage and each output port in output set B of a switch matrix unit being uniquely coupled to an input port in the other of the two switch matrix units in the next stage.

4. The system of claim 1 wherein the switch matrix unit programming is generated by a method with steps comprising:
obtaining information that identifies a specific subsystem input port and a desired subsystem output port for connecting to the specific subsystem input port;
identifying a pathway from a switch matrix unit in the cross connect system that provides the specific subsystem input port to a switch matrix unit in the cross connect system that provides the desired subsystem output port;
determining that sufficient channels exist in the identified pathway to allow a connection from the specific subsystem input port to the desired subsystem output port;
identifying specific channels in the identified pathway to allow a connection from the specific subsystem input port to the desired subsystem output port; and
storing in a programming data structure information identifying connections that have to be made in a plurality of switch matrix units in the cross connect system to allow the connection from the specific subsystem input port to the desired subsystem output port.

5. The system of claim 1 wherein the programming comprises instructions stored in memory.

6. The system of claim 1 wherein the programming comprises an arrangement of binary values stored in memory.

7. The system of claim 1 wherein the programming comprises software code stored in memory.

8. The system of claim 5 or 6 wherein the memory comprises Read Only Memory.

9. The system of claim 5 or 6 wherein the memory comprises Random Access Memory.

10. The system of claim 1 wherein the programming comprises a programmable circuit element that have been programmed.

11. The system of claim 10 wherein the programmable circuit element comprises an application specific integrated circuit.

12. The system of claim 10 wherein the programmable circuit element comprises a programmable logic array.

13. The system of claim 1 wherein each switch matrix unit comprises an application specific integrated circuit.

14. The system of claim 1 wherein each switch matrix unit comprises a square matrix.

15. The system of claim 1 wherein the number of input ports for each switch matrix unit is the same.

16. An apparatus that performs a switching function, comprising:
a plurality of switch matrix units each having input ports and output ports, at least six of said switch matrix units are organized in three stages with two switch matrix units in each stage, the inputs ports of the first stage switch matrix units being inputs ports for the apparatus and the output ports of the third stage switch matrix units being output ports for the apparatus, each first stage and second stage switch matrix unit having its output ports assigned to either an output set A or an output set B associated with that switch matrix unit, each output port in output set A of a switch matrix unit being uniquely coupled to an input port in one of the two switch matrix units in the next stage and each output port in output set B of a switch matrix unit being uniquely coupled to an input port in the other of the two switch matrix units in the next stage; each switch matrix unit being programmable to provide connections between its input ports and its output ports; and
switch matrix unit programming for each first stage, second stage and third stage switch matrix units, the programming instructing at least one of the first stage switch matrix units, at least one of the second stage switch matrix units and at least one of the third stage switch matrix units to each establish an internal connection that allows a signal appearing at one of the inputs of the apparatus to be switched to at least one of the outputs of the apparatus.

17. The apparatus of claim 16 wherein the programming is generated using a method with steps comprising:
obtaining information that identifies an input port of the apparatus and a desired output port of the apparatus for connecting to the identified input port;
identifying a pathway from a switch matrix unit in the apparatus that provides the identified input port to a switch matrix unit in the apparatus that provides the desired output port;
determining that sufficient channels exist in the identified pathway to allow a connection from the identified input port to the desired output port;
identifying specific channels in the identified pathway to allow a connection from the identified input port to the desired output port; and
storing in a programming data structure information identifying connections that have to be made in a plurality of switch matrix units in the apparatus to allow the connection from the identified input port to the desired output port.

18. A method for generating switch matrix unit programming for switch matrix units of a cross connect device, comprising:
obtaining information that identifies an input port of the cross connect device and a desired output port of the cross connect device for connecting to the identified input port;
identifying a pathway from a switch matrix unit in the cross connect device that provides the identified input port to a switch matrix unit in the cross connect device that provides the desired output port;
determining that sufficient channels exist in the identified pathway to allow a connection from the identified input port to the desired output port;
identifying specific channels in the identified pathway to allow a connection from the identified input port to the desired output port; and
storing in a programming data structure information identifying connections that have to be made in a plurality of switch matrix units in the cross connect device to allow the connection from the identified input port to the desired output port.

19. The method of claim 18 further comprising using the programming data structure to generate the switch matrix unit programming for switch matrix units of the cross connect device, the switch matrix unit programming identifying internal connections that have to be made within the switch matrix units to connect the identified input to the desired output.

20. The method of claim 18 wherein the step of identifying a pathway comprises identifying a preferred pathway instead of an alternate pathway.

21. The method of claim 20 wherein the step of identifying a preferred pathway comprises identifying the preferred pathway when the alternate pathway was identified in a prior iteration.

22. The method of claim 18 wherein the step of identifying a pathway comprises identifying an alternate pathway instead of a preferred pathway.

23. The method of claim 22 wherein the step of identifying an alternate pathway comprises identifying the alternate pathway when the preferred pathway was identified in a prior iteration.

24. The method of claim 18 wherein the step of determining that sufficient channels exist comprises:
remembering the number of available output ports for a plurality of the switch matrix units; and
determining that each switch matrix unit that has output ports in the identified pathway has an available output port.

25. The method of claim 24 wherein the remembering step comprises keeping a count of the number of output ports that are not available.

26. The method of claim 25 wherein the step of identifying specific channels comprises incrementing the count of output ports that are not available.

27. The method of claim 18 wherein the step of identifying specific channels comprises:
identifying specific output ports in specific switch matrix units that are in the identified pathway that are available; and
reserving the identified specific output ports for use in making the connection from the identified input port to the desired output port.

28. The method of claim 27 wherein the step of identifying specific output ports comprises:
assigning a numerical value to the output ports; and
identifying available output ports that have the lowest numerical value.

29. The method of claim 18 wherein the step of obtaining information that identifies an input port comprises obtaining information that identifies a plurality of input port and desired output port pairs.

30. The method of claim 29 wherein the input port and desired output port pairs are grouped such that all pairs having the same entry switch matrix unit and exit switch matrix unit are grouped together.

31. The method of claim 30 wherein the plurality of input port and desired output port pairs includes at least one input port that is to be connected to more than one output port.

32. The method of claim 31 wherein the input ports having the same entry switch matrix unit and multiple exit switch matrix units are grouped together.

33. The method of claim 32 wherein the steps of claim 8 are repeated for all of the input port and desired output port pairs.

34. The method of claim 33 wherein the input ports that are to be connected to more than one output port are selected for processing before the groups of input port and desired output port pairs having the same entry switch matrix unit and exit switch matrix unit.

35. A method for programming an apparatus having at least six switch matrix units wherein the six switch matrix units are organized in three stages with two switch matrix units in each stage, the inputs ports of the first stage switch matrix units being inputs ports for the apparatus and the output ports of the third stage switch matrix units being output ports for the apparatus, each first stage and second stage switch matrix unit having its output ports assigned to either an output set A or an output set B associated with that switch matrix unit, each output port in output set A of a switch matrix unit being uniquely coupled to an input port in one of the two switch matrix units in the next stage and each output port in output set B of a switch matrix unit being uniquely coupled to an input port in the other of the two switch matrix units in the next stage, each switch matrix unit being programmable to provide connections between its input ports and its output ports, the method comprising:
calculating a path for a signal on an input port for the apparatus to an output port for the apparatus; and
programming at least one of the first stage switch matrix units, at least one of the second stage switch matrix units and at least one of the third stage switch matrix units to each establish an internal connection that allows a signal appearing at the input port for the apparatus to be connected to an output port for the apparatus.

36. The method of claim 35 wherein the calculating step comprises identifying a pathway from a switch matrix unit in the apparatus that provides the input port to the switch matrix unit in the apparatus that provides the desired output port;
determining that sufficient channels exist in the identified pathway to allow a connection from the identified input port to the desired output port; and
identifying specific channels in the identified pathway to allow a connection from the identified input port to the desired output port.
